(19) United States
(12) Patent Application Publication
(10) Pub. No.: US 2010/0192054 A1
(43) Pub. Date: Jul. 29, 2010

(54) SEMATICALLY TAGGED BACKGROUND INFORMATION PRESENTATION

(75) Inventors: Andreas Nauerz, Boblingen (DE); Michael P. Junginger, Stuttgart (DE); Achim Staebler, Stuttgart (DE); Martin Welsch, Herrenberg (DE)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/362,053

(22) Filed: Jan. 29, 2009

(51) Int. Cl. G06F 17/00

(52) U.S. Cl. 715/234

(57) ABSTRACT

A method of associating information with a portal in a computing system includes receiving at a server a markup of a web page to be rendered at a portal layer; analyzing, at an analysis layer including an analysis engine, the semantic content of the markup; injecting the markup into its Document Object Model (DOM) via JavaScript logic to wrap information pieces into semantic tags in a semantic layer; connecting to a database to track all occurrences of semantically tagged information pieces and user-generated annotation; and rendering the markup to a user, the rendered markup including background information related to the semantically tagged information pieces.

### BACKGROUND

The present invention relates to web portals, and more specifically, to associating information with portions of a web page.

A web portal, or portal, is a site that provides a single function via a web page or site. Web portals often function as a point of access to information on the World Wide Web (also referred to herein as the “Internet”). Portals present information from diverse sources in a unified way. Apart from the search engine standard, web portals offer other services such as e-mail, news, stock prices, infotainment, and other features. Portals provide a way for enterprises to provide a consistent look and feel with access control and procedures for multiple applications, which otherwise would have been different entities altogether. An example of a web portal is MSN.

A typical prior art portal is built by a complex functionality implemented on a network server—for example an application server. The sever includes several key elements including logic components for: user authentication; state handling; and aggregation of fragments. The server may also include portal storage resource which includes a portal content model, a plurality of pages and portlets having Application Program Interfaces (API's) stored in a portlet container software for setting them into the common page context, and some portal storage resources. The logic components are operatively connected such that data can be exchanged between single components as required.

The portal realizes a request/response communication pattern, i.e. it waits for client requests and responds to these requests. A client request message includes a Universal Resource Location/Universal Resource Identifier (URL/URI) which addresses the requested portal page and/or other portal resources.

In modern Web 2.0 Portals have become highly collaborative participation platforms. Users not only retrieve information, they are allowed to contribute content. Due to the large number of different users contributing, Web 2.0 sites grow quickly and, most often, in a more uncoordinated way than centrally controlled sites. Furthermore, the expertise of users contributing often differs, and what might be clear for one user might be totally unknown for another one. The ability to find in place, in-context background information without the need to fire up search engines is often sought by users.

### SUMMARY

According to one embodiment of the present invention, a method of associating information with a portal in a computing system is provided. The method includes receiving at a server a markup of a web page to be rendered at a portal layer. Analyzing at an analysis layer, including an analysis engine, the semantic content of the markup. Injecting the markup into its Document Object Model (DOM) via JavaScript logic to wrap information pieces into semantic tags in a semantic layer. Connecting to a database to track all occurrences of semantically tagged information pieces and user-generated annotation. Rendering the markup to a user, the rendered markup including background information related to the semantically tagged information pieces.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustration of a portal in accordance with an embodiment of the present invention;

FIG. 2 is a flow diagram of a render request process in accordance with an embodiment of the present invention; and,

FIG. 3 illustrates an exemplary data flow through a six-layer architecture according to an embodiment of the present invention.

### DETAILED DESCRIPTION

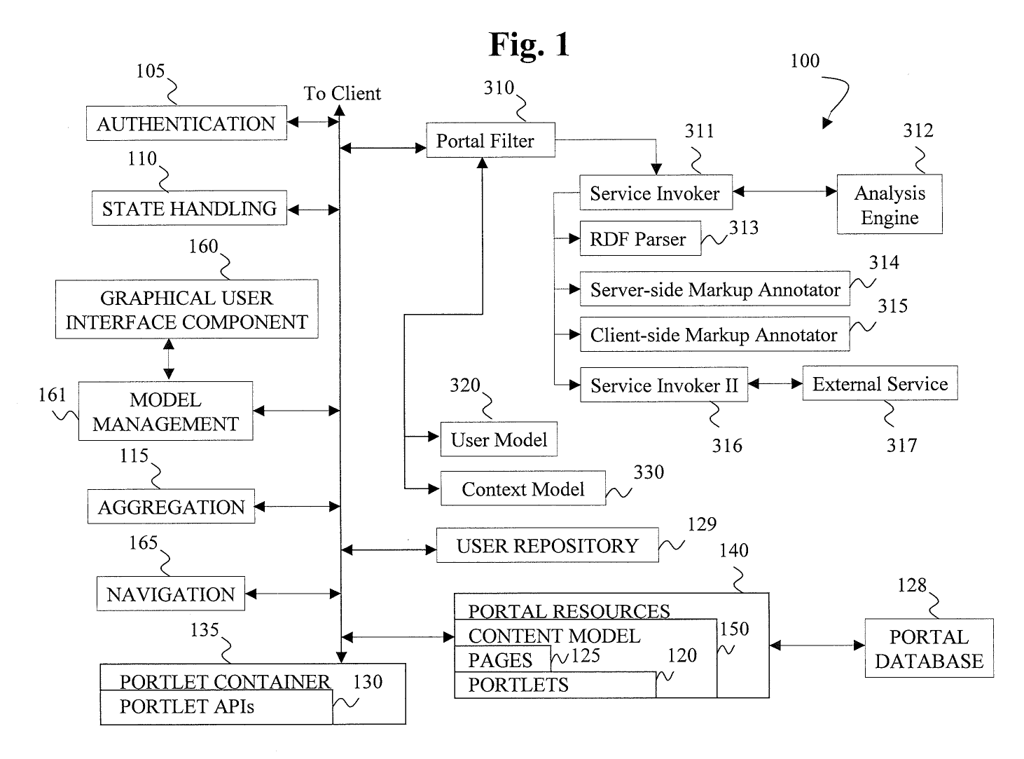

FIG. 1 shows an example of a portal 100 according to an embodiment of the present invention. The portal 100 implements an aggregation of portlets 120 based on the underlying portal content model 150 (stored in the portal resources 140) comprising a hierarchy of portal pages 125 that may include portlets 120 and portal information such as security settings, user roles, customization settings, and device capabilities.

Within a rendered page, the portal 100 automatically generates the appropriate set of navigation elements based on the portal content model 150. The portal 100 invokes portlets 120 during the aggregation as required and, when required, uses caching to reduce the number of requests made to Portlets. One prior art solution utilized open standards such as the Java Portlet API. It also supports the use of a remote Portlet via the WSRP standard.

The portlet container 135 is a single control component competent for all portlets 120, which may control the execution of code residing in each of the portlets. It provides the runtime environment for the portlets and facilities for event handling, inter-portlet messaging, and access to portlet instance and configuration data, among others. The portal resources 140 are in particular the portlets 120 themselves and the pages 125 on which they are aggregated in the form of an aggregation of fragments and the navigation model 165. A portal database 128 stores the portlet description which may include attributes like portlet name, portlet description, portlet title, portlet short title, and keywords. The portal database 128 also stores the content model which defines the portal content structure, i.e. the structure of pages and comprises page definitions. A page definition describes a portal page and references the components (e.g. portlets) that are contained in this page. This data is stored in the database 128 in an adequate representation based on prior art techniques such as, for example, relational tables. The portals may also contain a navigation component 165 which provides the possibility to nest elements and to create a navigation hierarchy which may be stored in the portal content model 150.

An important activity in the rendering and aggregation processes is the generation of URLs that address Portal resources, e.g. pages. A URL is generated by the aggregation logic 115 and includes coded state information. The aggregation state as well as the portlet state is managed by the portal 100. Aggregation state can include information like the current selection including the path to the selected page in the portal model, the portlets modes and states, the portlet render, action parameters, etc. By including the aggregation state in a URL, the portal 100 ensures that it is later able to establish the navigation and presentation context when the client sends a request for this URL.

A portlet 120 can request the creation of a URL through the related portlet API 130 and provide parameters, i.e., portlet render and action parameters, to be included in the URL. The user repository 129 contains user information and authentication information for each portal user. The user repository 129 may be implemented in a database or a prior art LDAP directory. The user repository supports various retrieval operations to query information about one user, multiple users or all portal users.

A graphical user interface component 160 is provided for manually controlling the layout of the plurality of rendered pages. The graphical user interface component 160 allows an administrator of the portal 100 (or a user that is enabled) to control the visual appearance of the portal pages (e.g. by creating new pages, by adding or removing portlets on pages). In particular, the administrator or user can decide which portlet is included at a given portal web page by adding portlets to pages or by removing portlets from pages. The graphical user interface component 160 invokes the model management module 161 which include the functionality for performing persistent content model changes and offers an API for invoking this functionality.

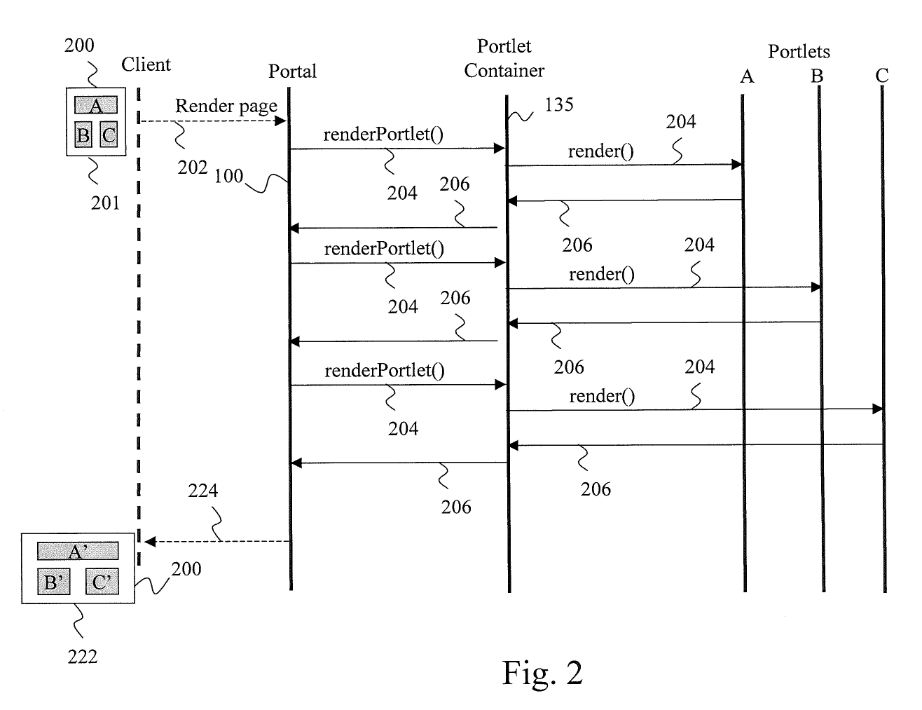

The previous description has detailed a portion the Portal 100. This portion may be operational on its own or may include additional components as described below. The following description related to FIG. 2 is related to the operation of the system without the later described components.

FIG. 2 shows a flow diagram of a render request process. A client 200 (which may be implemented, for example, as a computing device as shown in Fig. X) may display a portlet markup 201 (containing, for example portlets A, B, and C) of respective portlets in the client browser. The portal 100 and the portlet container 135 are shown as single lines as are the individual portlets 120 (A, B, C). In FIG. 2 communication is based on requests that are expressed in the directions shown in the arrows. The following description of FIG. 2 also refers to elements shown in FIG. 1.

The client 200 issues a render request 202, e.g. for a new page, by clicking on a link displayed in its browser window. The link contains a URL and in response to the user action, the client 200 issues the render request 202 containing the URL. To render this new page, the portal 100—after receiving the render request 202—invokes state handling logic 110 passing the URL. The state handling logic then determines the aggregation state and the portlet state that is encoded in the URL or is associated with the URL. Typically the aggregation state logic 115 contains an identification of the requested page. The aggregation logic 115 checks if a derived page exists for this user. The aggregation logic loads the related page definition from the portal database and determines the portlets that are referenced in this page definition, i.e. that are contained on the page. It sends an own portlet render request 204 to each portlet 120 through the portlet container 135. As shown, a portlet render request 204 is send for each portlet A, B, and C.

In the prior art, each portlet A, B and C creates its own markup independently and returns the markup fragment with the respective request response 206. The portal 100 aggregates the markup fragments and returns the new page 222 to the client 100 in a response 224.

Some prior art portals support the concept of page derivation. This concept allows for a stepwise specialization of a page. In the first step, administrator A creates a page, defines a base layout, and adds content (i.e. portlets) to the page. After that, the administrator grants appropriate rights to other administrators or users, who themselves can derive the page and edit the layout and content of a page, but not any locked elements.

When an administrator or a user modifies the page, the model management function of the prior art creates a derivation of the page and stores it into the portal database. It also stores an association between the implicit derivation and the user that performed the page modification.

For example, Administrator A creates a page X that comprises portlet A, Administrator B adds portlet B to page X, which results in the creation of the derived page X′, and user C is authorized to view the page X (and thus X′). In this case, when issuing a request for page X, Administrator A will see portlet A (corresponding to page X), Administrator B will see Portlet A and B (corresponding to page X′) and user C will also see portlets A and B (corresponding to page X′). Prior art aggregation logic automatically selects the according page during request processing based on aggregation state and the id of the user issuing the request.

Now suppose user C modifies the page to include portlet C. Portal thus creates a new derive page X″ and stores this into the database. The derived page is associated with user C. When invoking a request for page X now, Administrator A will see portlet A, Administrator B will see Portlet A and B (corresponding to page X′) and user C will see portlets A, B and C (corresponding to page X″).

Embodiments of the present invention allow for in-place, in-context access to background information with respect to a certain term or topic. These embodiments include additional elements than those previously described that include, for example, a portal filter, a service invoker and an RDF parser. In one embodiment, these components may be invoked by portal aggregation logic. This solution is based on the identification of semantics of text fragments which may be wrapped into semantic tags which may be associated with services able to provide these background information. To determine semantics of text fragments a service, such as, for example, OpenCalais may be included in the system described above. Regardless of the service used the service should be able to automatically annotate content with rich semantic metadata.

In addition, the provisioning of in-place, in-context background information can also be provided based on constructed user models reflecting interests and preferences. Here, only those fragments could be highlighted that match users interests. For example, a user interested in Portal Technology might see terms highlighted like JSR168, JSR268, WSRP etc. Conversely, the opposite could be done as well. That is, only information that user already know may be highlighted. In this case the user model may be correlated with the user's expertise model which contains things the user already has expertise.

Referring again to FIG. 1, the portal 100 may further include a portal filter 310. In one embodiment, the entire markup to be transmitted between server 100 and client is first transmitted through the portal filter 310 for further analysis. The filter 100 first causes the entire markup to be processed by the service invoker 311 which in turn causes the entire markup to be processed by some sort of analysis engine 312 that could e.g. identify entities being of a certain type. One example of such a service engine is OpenCalais, which enriches the supplied content with semantic metadata.

The analysis engine 312 returns RDF data describing the identified entities. This RDF data is parsed by an RDF parser 313. In one embodiment, the filter 310, through polling the user model 320 or the context model 330 (or both), determines interests and preferences of the respective user and then wraps the “interesting” entities into semantic tags utilizing the server-side markup annotator 314 and the client side markup annotator 315. The semantic tags may be used by the external services 316 and 317 to provide the user with “interesting” background information. For example, the semantic tags may be launched into a search in an external service such as “Wikipedia” or the like.

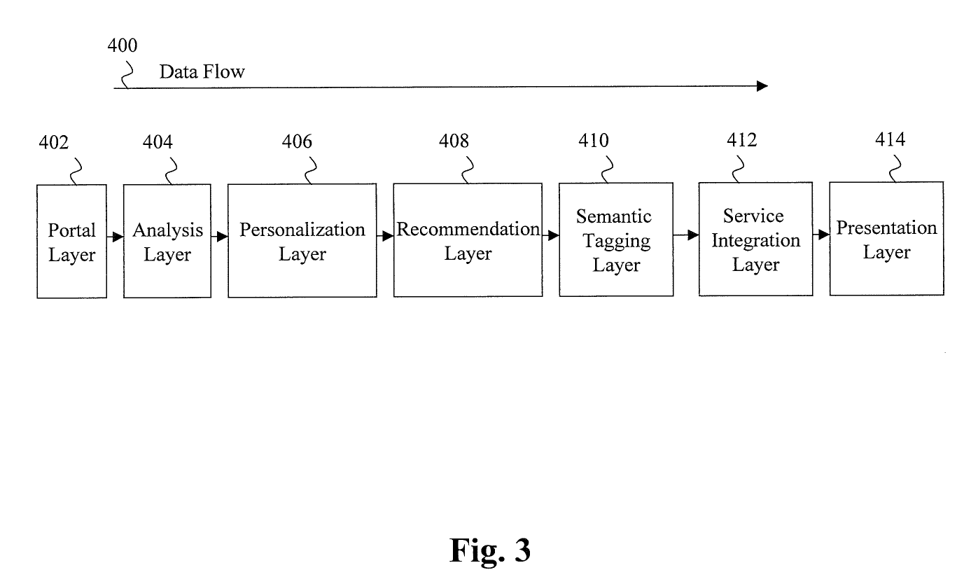

FIG. 3 shows an example of the data flow (indicated by arrow 400) through a six layer architecture according to one embodiment of the present invention. Content (in the form of markup) is delivered by the portal (more precisely, by portlets residing on pages) via the portal layer 402. The content is then analyzed by analysis engines in the analysis layer 404. The engines may include, for example, so called annotators that extract information pieces like people, locations etc. from the markup received. At the personalization layer 406 information related to a particular user is received. Then, at the semantic tagging layer 408 the results of the analysis from the analysis layer 404 are converted into proper markup format. This means that markup may wrapped around the information pieces is created. In other words, actual semantic tagging is performed at this layer.

The recommendation layer 410 determines other occurrences of the same semantic tags and occurrences of similarly user-annotated information pieces. At the service integration layer 412 (external) services to which the each single semantic tag should be connected to provide users with additional information is determined. For example, for a semantic tag corresponding to a person the service integration layer may connect against the company's employee directory, or against Google Maps to visualize the work location of the person. At the presentation layer 414, application logic is applied to the semantic tags that allows for the actual interaction (i.e. for the invocation of (external) services etc.).

In more detail, content to be rendered, in the form of a markup, usually in HTML, enters the system through the portal layer 402. The content is neither tagged nor annotated at this point. In one embodiment, the portal layer 402 may include a tagging filter and a tagging engine. The portal layer 402, via the portal filter 310 (FIG. 1), passes the markup to the subsequent layers before delivering it to the client. The tagging engine allows resources to be annotated directly.

The analysis layer 404 receives the content to be analyzed from the portal layer 402 and includes analysis engines. In the analysis layer 404, utilizing the UIMA framework contained in a UIAM annotator person names, locations, currencies, abbreviations, and terms defined in encyclopedias may be detected.

The annotated objects are passed to the semantic tagging layer 408 which injects markup into the current markups' Document Object Model (DOM) via JavaScript logic to wrap information pieces into semantic tags. In one embodiment, Velocity (http://velocity.apache.org/) templates are utilized. The semantically tagged content is then passed to the recommendation layer 410 which connects against a database in which track all occurrences of semantically tagged information pieces and user-generated annotation are tracked. The layer determines the previously mentioned lists to allow us to recommend related content.

The service integration layer 412 similarly determines the external service connectors. For person names, a lookup to the person's profile in the company's employee directory, his blog entries in the companywide blogosphere, his forum posts and his geographic location by connecting against Google Maps may be accessed. For locations embodiments may allow for looking up details by connecting against Google Maps, too. For currencies embodiments may allow for in-place currency conversion using an external currency conversion service. For abbreviations embodiments may allow for the lookup of the abbreviations meaning and, finally, for words defined in encyclopedias embodiments may provide access to the corresponding entries e.g. in Wikipedia (http://en.wikipedia.org/). Finally, the presentation layer 414 generates the client-side application logic allowing to interact with the semantically tagged information pieces. The client-side code may be realized making use of Dojo (http://dojotoolkit.org/) widgets.

The above description assumes and is directed to utilization of a computing device as may be know in the art or later developed.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of associating information with a portal in a computing system, the method comprising:
receiving at a server a markup of a web page to be rendered at a portal layer;
analyzing, at an analysis layer including an analysis engine, the semantic content of the markup;
injecting the markup into its Document Object Model (DOM) via JavaScript logic to wrap information pieces into semantic tags in a semantic layer;
connecting to a database to track all occurrences of semantically tagged information pieces and user-generated annotation; and
rendering the markup to a user, the rendered markup including background information related to the semantically tagged information pieces.

2. The method of claim 1, further comprising:
invoking an external service to locate the background information.

3. The method of claim 2, further comprising:
determining the external service to invoke based on the content of the semantically tagged information.
